(19) United States
(12) Patent Application Publication
(10) Pub. No.: US 2015/0081657 A1
(43) Pub. Date: Mar. 19, 2015

(54) METHOD AND APPARATUS FOR PROVIDING SEARCH SERVICE BASED ON KNOWLADGE SERVICE

(71) Applicant: KOREA ADVANCED INSTITUTE OF SCIENCE AND TECHNOLOGY, Daejeon (KR)

(72) Inventors: Mun Yong YI, Daejeon (KR); Won Chul JUNG, Daejeon (KR)

(73) Assignee: KOREA ADVANCED INSTITUTE OF SCIENCE AND TECHNOLOGY, Daejeon (KR)

(21) Appl. No.: 14/045,707

(22) Filed: Oct. 3, 2013

(30) Foreign Application Priority Data
Sep. 13, 2013 (KR) 10-2013-0110606

(51) Int. Cl. G06F 17/30

(52) U.S. Cl. CPC G06F 17/30864; G06F 17/301
USPC 707/706

(57) ABSTRACT

Provided is a method and apparatus for providing search service based on a knowledge structure. The method includes; searching and providing a document corresponding to a query input by a user; generating a knowledge structure corresponding to the document and additionally providing the knowledge structure; when one of a plurality of keywords included in the knowledge structure is selected, additionally searching relevant documents including the keyword; calculating document similarity by comparing and analyzing the knowledge structure of the document and knowledge structures of the relevant documents; and performing a document recommending operation or a document providing operation based on the similarity calculation result.

### CROSS-REFERENCE TO RELATED APPLICATIONS

This application claims priority under 35 U.S.C. §119 to Korean Patent Application No. 2013-0110606, filed on Sep. 13, 2013, in the Korean Intellectual Property Office, the disclosure of which is incorporated herein by reference in its entirety.

### TECHNICAL FIELD

The present disclosure relates to a search service providing technique, and more particularly, to a method and apparatus for providing search service based on a knowledge structure, which checks a knowledge structure of each information and provides information necessary for a user to be searched by the user.

### BACKGROUND

The present society called a knowledge society or information society comes to a Zeta Byte era since ability for knowledge-based businesses is a key point of social productivity, and knowledge information, the core of such business ability, is poured out constantly.

In such a change of time, desires of people on knowledge information become more complicated and diversified, but an existing knowledge information searching method generally allows searching knowledge information based on just a query submitted by a user.

However, recently, a study for applying an associative concept among search words to a searching work has been researched, and as a result the query extension for expanding search words based on a query submitted by a user has been proposed.

Query extension has a concept of expanding the number of search words used for a query by using a thesaurus or external resources. However, the query extension does not consider relations among the expanded search words, and the number of expanded search words is also limited. In addition, the query extension cannot fundamentally reflect associative relations among words included in a document.

### SUMMARY

The present disclosure is directed to providing a method and apparatus for providing search service based on a knowledge structure, which may extract important keywords in a document, express relations among the keywords as a knowledge structure, and then provides information necessary for a user to be searched by the user with reference to the knowledge structure.

According to an aspect of the present invention, there is provided a method for providing search service based on a knowledge structure, which comprises: searching and providing a document corresponding to a query input by a user; generating a knowledge structure corresponding to the document and additionally providing the knowledge structure; when one of a plurality of keywords included in the knowledge structure is selected, additionally searching relevant documents including the keyword; calculating document similarity by comparing and analyzing the knowledge structure of the document and knowledge structures of the relevant documents; and performing a document recommending operation or a document providing operation based on the similarity calculation result.

The calculating of document similarity includes: when one of a plurality of keywords included in the knowledge structure is selected, additionally searching relevant documents including the keyword; checking a knowledge structure of each of the relevant documents, and then extracting keywords included in the knowledge structure; generating a document keyword similarity matrix of a two-dimensional structure by utilizing the relevant documents as item information in a first direction and the extracted keywords as item information in a second direction perpendicular to the first direction; and calculating document similarity by interpreting the document keyword similarity matrix.

Wherein said calculating of document similarity uses a previously registered similarity calculating algorithm.

The method further comprising: before said generating of a document keyword similarity matrix, setting a search range of the relevant documents.

Wherein the search range of the relevant documents is any one of a search range including all documents uploaded on database or the Internet, a search range including documents corresponding to the query input by the user, and a search range including documents belonging to a category selected by the user.

Wherein the knowledge structure is expressed by a plurality of nodes respectively corresponding to main keywords included in the document and a plurality of links showing meaning proximity of the nodes.

Wherein in said additionally searching of relevant documents including the keyword, the selected keyword is any one of a keyword included in the knowledge structure and a recommended keyword associated with the keyword.

The method further comprising: when one of a plurality of keywords included in the knowledge structure is selected, additionally displays visual information to show links and nodes connected to a node corresponding to the selected keyword to recommend of other keywords corresponding to the selected keyword.

According to another aspect of the present invention, there is provided an apparatus for providing search service based on a knowledge structure, comprising: a search engine for searching a document corresponding to a query or keyword selected by a user; a knowledge structure managing unit for generating a knowledge structure corresponding to the document; a control unit for acquiring and displaying documents corresponding to the query through the search engine when the query is input by the user, acquiring and displaying a knowledge structure of the selected document, and searching and recommending or providing a document having a knowledge structure most similar to the knowledge structure of the selected document when a keyword included in the knowledge structure is selected; and a knowledge structure managing unit for generating a knowledge structure corresponding to the selected document and providing the knowledge structure to the control unit.

Wherein when one of a plurality of keywords included in the knowledge structure is firstly selected, the control unit further recommends other keywords associated with the firstly selected keyword.

The object of the present disclosure is not limited to the above, and other objects not mentioned herein will be clearly understood from the following disclosure by those having ordinary skill in the art.

In the present disclosure, the content of a document may be checked at a glance through a mechanically prepared knowledge structure, and an information searching operation may be performed based on the knowledge structure, thereby greatly improving the accuracy of the information searching work.

In addition, new knowledge may be acquired through relations of keywords in the knowledge structure, and further relevant knowledge may be expanded more easily through interested keywords.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a diagram for illustrating the concept of a knowledge structure;

FIG. 2 is a diagram for illustrating a knowledge structure generating method according to an embodiment of the present disclosure;

FIG. 3 is a diagram showing an example of a knowledge structure generated by the knowledge structure generating method of FIG. 2;

FIG. 4 is a diagram for illustrating a method for providing search service based on a knowledge structure according to an embodiment of the present disclosure;

FIG. 5 is a diagram for illustrating a query inputting and document selecting operation according to an embodiment of the present disclosure;

FIG. 6 is a diagram showing examples of a knowledge structure display method according to an embodiment of the present disclosure;

FIG. 7 is a diagram showing examples of a knowledge structure respectively corresponding to documents according to an embodiment of the present disclosure;

FIG. 8 is a diagram showing an example of a document keyword similarity matrix according to an embodiment of the present disclosure;

FIG. 9 is a diagram showing examples of document recommendation or provision according to an embodiment of the present disclosure;

FIG. 10 is a diagram showing examples of a method for providing search service based on a knowledge structure according to another embodiment of the present disclosure;

FIG. 11 is a diagram for illustrating a keyword recommendation concept according to another embodiment of the present disclosure; and

FIG. 12 is a diagram for illustrating a search service providing apparatus for providing information search service based on a knowledge structure according to an embodiment of the present disclosure.

### DETAILED DESCRIPTION OF EMBODIMENTS

For better understanding of the present disclosure, prior to explaining the present disclosure, the concept of a knowledge structure will be described.

The knowledge structure is a model systematically showing core constructs generated when a learner learns through a certain document or media and their associative relations based on their proximity, and a line connected between two concepts represents that two concepts have a close meaningful relationship. The knowledge structure is called a cognitive schema in the cognitive science.

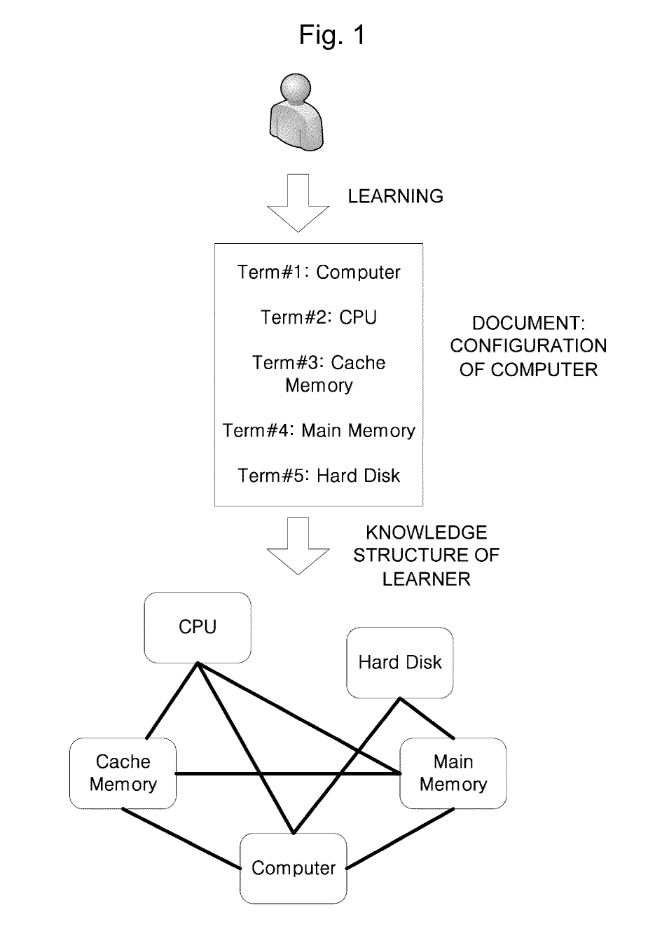

For example, assuming that a learner learns a document “Configuration of Computer” as shown in FIG. 1 and core constructs in the corresponding document are Computer, CPU, Cache Memory, Main Memory and Hard Disk, the learner learning the corresponding document may imagine a structure in which the core constructs are interconnected through their associative relations, and this organized system may be the knowledge structure.

In this regard, in the present disclosure, a separate computing device analyzes data uploaded on database or the Internet and allows a corresponding knowledge structure to be automatically generated, and further other data may also be recommended or provided based on a knowledge structure corresponding to each data.

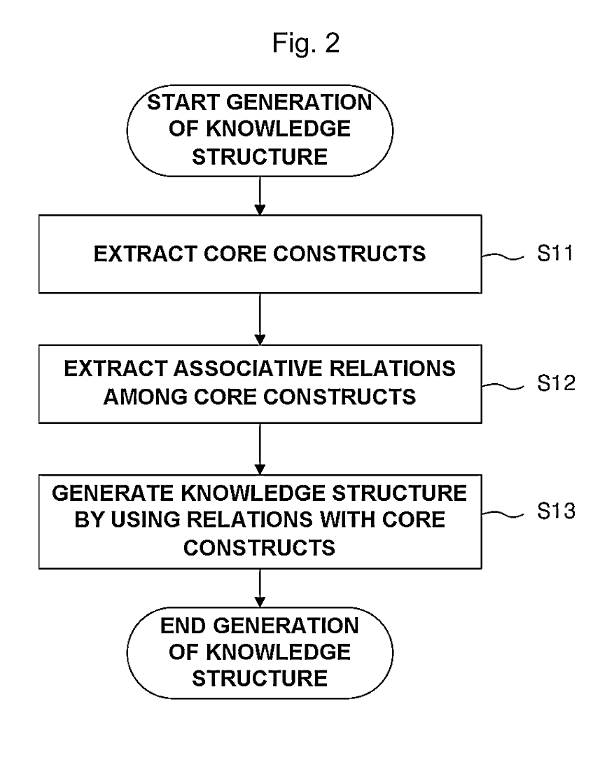

FIG. 2 is a diagram for illustrating a knowledge structure generating method according to an embodiment of the present disclosure.

Referring to FIG. 2, the knowledge structure generating method according to the present disclosure is to extract a knowledge structure from a single document which is a smallest unit of data, and may generally include extracting core constructs of a single document (S11), extracting associative relations among the core constructs (S12), and generating a knowledge structure by using relations with the core constructs (S13).

In Operation of extracting core constructs (S11), morphemes of the single document are analyzed to select only nouns among words included in the document, and then main keywords, namely core constructs, are extracted based on a word use frequency.

In Operation of extracting associative relations among the core constructs (S12), associative relations among the core constructs of the document are extracted by using co-occurrence information of word pairs.

In the present disclosure, the co-occurrence information is divided into sentence co-occurrence information which represents a frequency of co-occurrence in two sentences having the same concept and paragraph co-occurrence information which represents a frequency of co-occurrence in two paragraphs having the same concept, and then associative relation similarity among concepts is measured by using simple co-occurrence information.

Equation 1 is an equation to obtain word similarity obtained by using sentence co-occurrence information (Sentence co-occurrences Similarity: SS), and Equation 2 is an equation to obtain word similarity obtained by using paragraph co-occurrence information (Paragraph co-occurrences Similarity: PS).

$$\begin{matrix}{SS}_{ij} = \frac{\{ {\sum }_{1}^{{N}_{S}} n ( {W}_{i} ⋂ {W}_{j} ) \}}{Max ( {C}_{S} )} , ( 0 \leq SS \leq 1 ) & Equation 1 \\ {PS}_{ij} = \frac{\{ {\sum }_{1}^{{N}_{P}} n ( {W}_{i} ⋂ {W}_{j} ) \}}{Max ( {C}_{P} )} , ( 0 \leq PS \leq 1 ) & Equation 2\end{matrix}$$

At this time, Nₛ and Nₚ respectively become a sentence number and a paragraph number according to the order shown in the document.

Word similarity is normalized into a value between 0 and 1 by dividing the sum of co-occurrence frequency of each sentence or each paragraph by a maximum value of the document or paragraph co-occurrence information shown in the document.

Word similarity may be easily measured according to the above equations by using the co-occurrence information, but this method has a problem in that similarity relationship with other words increases if the corresponding work appears frequently. In order to solve this problem, a cosine similarity measuring method widely used for grouping documents is used in a modified state.

TABLE 1

| | sentence 1 | sentence 2 | sentence 3 | . . . | sentence N |
|---|---|---|---|---|---|
| Wi | 3 | 0 | 1 | . . . | 1 |
| Wj | 2 | 1 | 0 | . . . | 2 |

As in Table 1, an inverted sentence vector (ISV) composed of frequencies of concepts in each sentence is generated.

$${SCS}_{ij} = \frac{{v}_{i} \cdot {v}_{j}}{‖ {v}_{i} ‖ \times ‖ {v}_{j} ‖} , ( 0 \leq SCS \leq 1 ) \qquad Equation 3$$

After that, cosine similarity among concepts (Sentence co-occurrences Cosine Similarity: SCS) may be measured from the single document by using Equation 3.

Cosine similarity among concepts (Paragraph co-occurrences Cosine Similarity: PSC) may be measured in the same way by changing the sentence number of Table 1 into a paragraph number, and this method is suitable for measuring concept associative relations in the single document since similarity is measured according to the degree of co-occurrence regardless of the frequency of the word.

In Operation of generating a knowledge structure (S13), first, the associative relation Dᵢⱼ of concepts is converted into a 7-point scale by using Equation 4, similar to the method frequently used in an existing knowledge structure generating process in the cognitive psychology field (1: very relevant, 7: not relevant)

Dᵢⱼ=7−Sᵢⱼ×6,(1≦Dᵢⱼ≦7) Equation 4

After that, a similarity measurement table composed of associative relations among concepts is made, and a knowledge structure for connecting the concepts by the shortest distance is automatically generated by applying a pathfinder algorithm, a 7-scale score or the like.

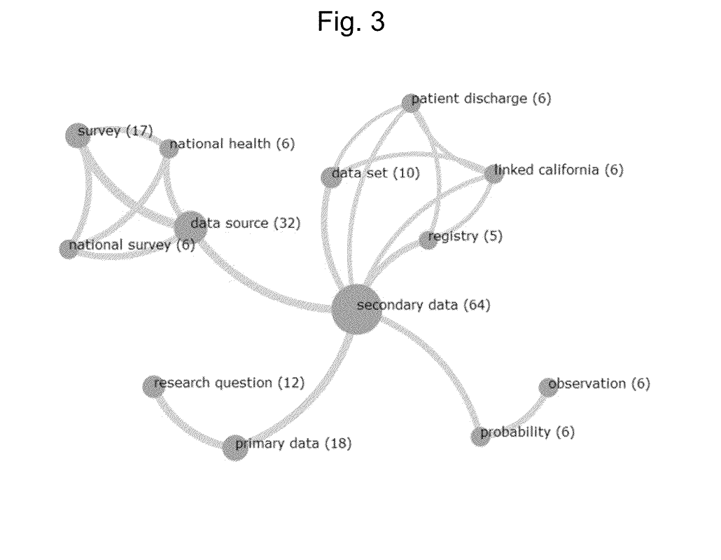

FIG. 3 is a diagram showing an example of a knowledge structure generated by the knowledge structure generating method of FIG. 2.

Referring to FIG. 3, it may be understood that the knowledge structure of the present disclosure may be expressed by a plurality of nodes and a plurality of links.

The plurality of nodes respectively corresponds to main keywords included in the document and may be expressed as various figures (for example, a circle, a rectangular or the like) having a predetermined area. In addition, by changing the shape of the node (namely, a node size or color) in proportion to the keyword occurrence frequency, an occurrence frequency of the corresponding frequency may be easily checked only with the node shape.

The plurality of links represents associative relations among nodes and may be expressed as lines having different thicknesses, colors, kinds or the like according to relations among keywords connected by the corresponding link (namely, association, relation).

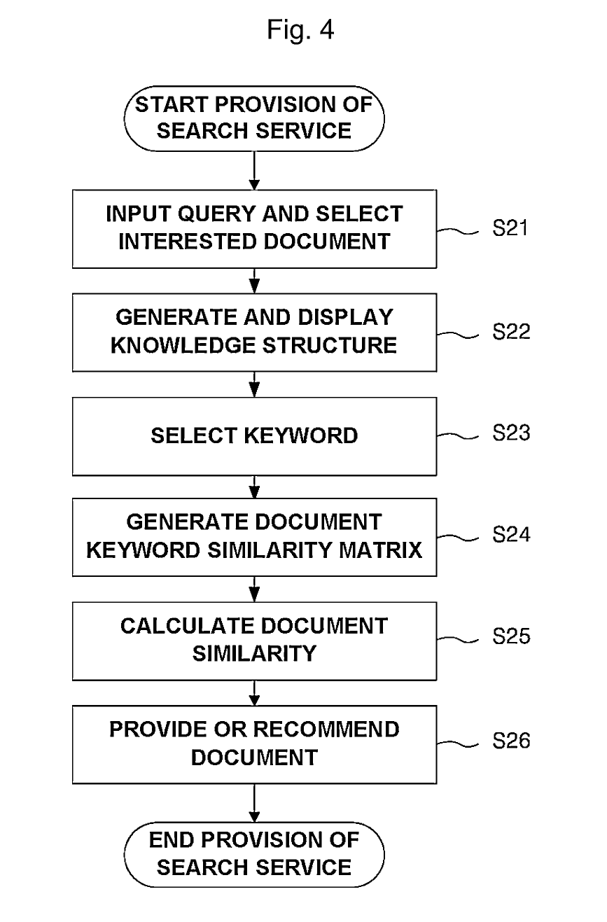

FIG. 4 is a diagram for illustrating a method for providing search service based on a knowledge structure according to an embodiment of the present disclosure.

Referring to FIG. 4, the information search method of the present disclosure may include inputting a query and selecting a document (S21), generating and displaying a knowledge structure (S22), selecting a keyword (S23), generating a document keyword similarity matrix (S24), calculating document similarity (S25), providing or recommending a document (S26) or the like, in brief.

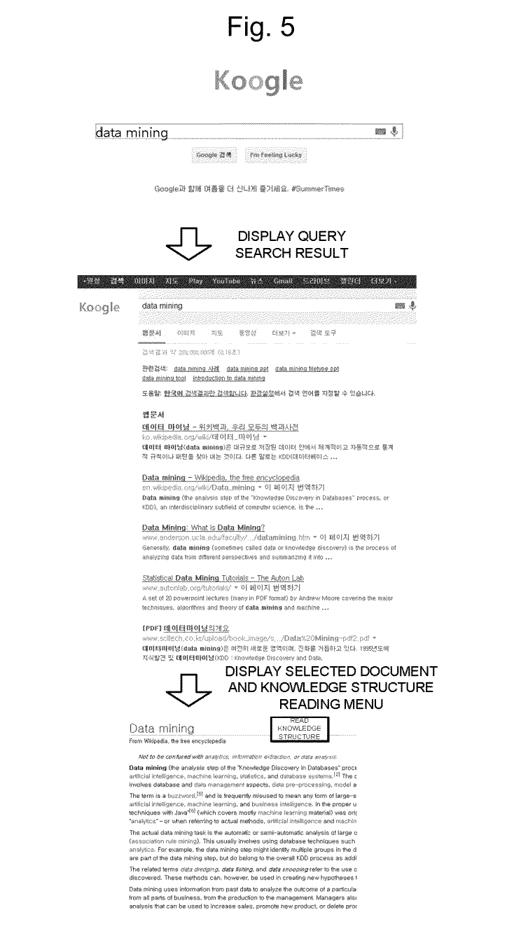

First, in Operation of inputting a query and selecting a document (S21), as shown in FIG. 5, the apparatus for providing search service provides a search window in which an Internet user may input a query to be searched. If a query is input through the search window, all documents in a database of the search engine (or, all documents uploaded on the Internet) are searched to obtain documents corresponding to the query, and the documents are displayed as a list.

If the user selects one interested document among the documents corresponding to the query, the apparatus for providing search service gives a pop-up window or opens a new web page to display detailed information of the selected document. In addition, a menu for allowing the user to request reading a knowledge structure of the corresponding document may be provided by allocating a predetermined region of the pop-up window or the new web page.

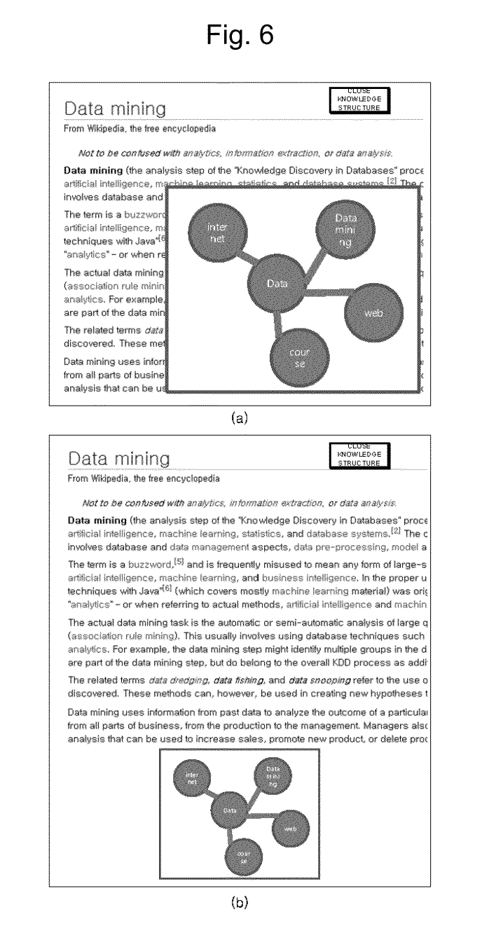

If the user selects the knowledge structure reading menu, Operation of generating and displaying a knowledge structure (S22) is performed, and the apparatus for providing search service generates a knowledge structure corresponding to the document by using the method of FIG. 2. In addition, the knowledge structure is additionally displayed at the pop-up window or the web page corresponding to the document. At this time, the knowledge structure may be provided through a separate pop-up window as shown in Portion (a) of FIG. 6 or displayed in a partial region allocated in the web page as shown in (b) of FIG. 6.

In other words, in the present disclosure, through the above process, the knowledge structure corresponding to the document is visually guided to the user, and also the user is allowed to more easily search or select a keyword necessary to recommend or provide documents.

In Operation of selecting a keyword (S23), it is monitored whether the user selects one of the plurality of keywords included in the knowledge structure as an interested keyword, and if an interested keyword is selected, Operation of generating a document keyword similarity matrix (S24) is performed.

In Operation of generating a document keyword similarity matrix (S24), the apparatus for providing search service additionally searches relevant documents including the interested keyword, and checks a knowledge structure of each of the relevant documents. In addition, the apparatus extracts keywords included in the knowledge structure, and then generates a document keyword similarity matrix of a two-dimensional structure by utilizing the relevant documents as item information in a first direction and the extracted keywords as item information in a second direction perpendicular to the first direction.

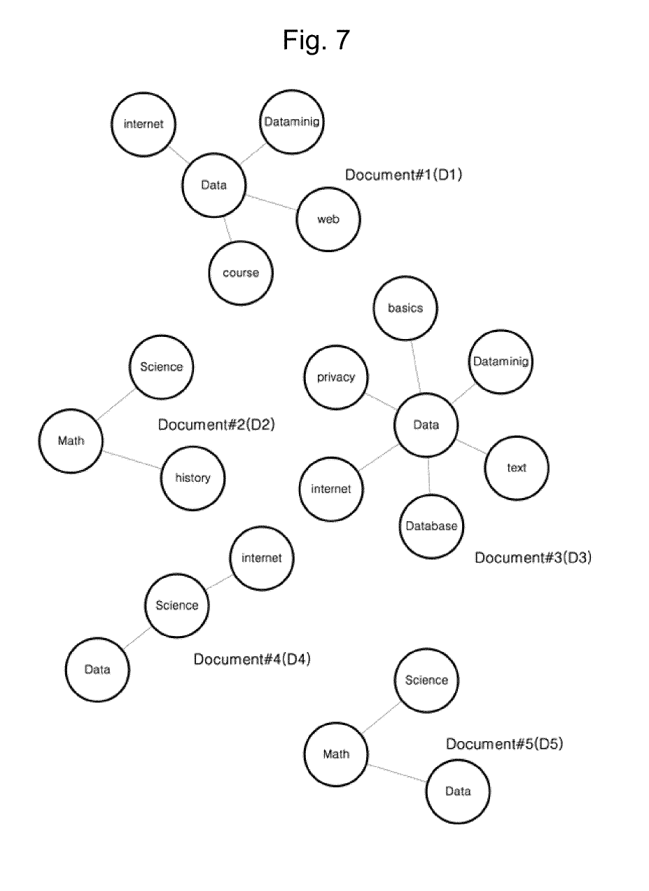

For example, if the user selects “Data” as an interested keyword among the plurality of keywords included in the knowledge structure corresponding to a document D1 as shown in FIG. 7, the apparatus for providing search service obtains only documents D3 to D5 having the keyword “Data” from the documents D2 to D5, excludes the document D2 since it does not have the corresponding keyword, and generates a knowledge structure of each of the documents D3 to D5.

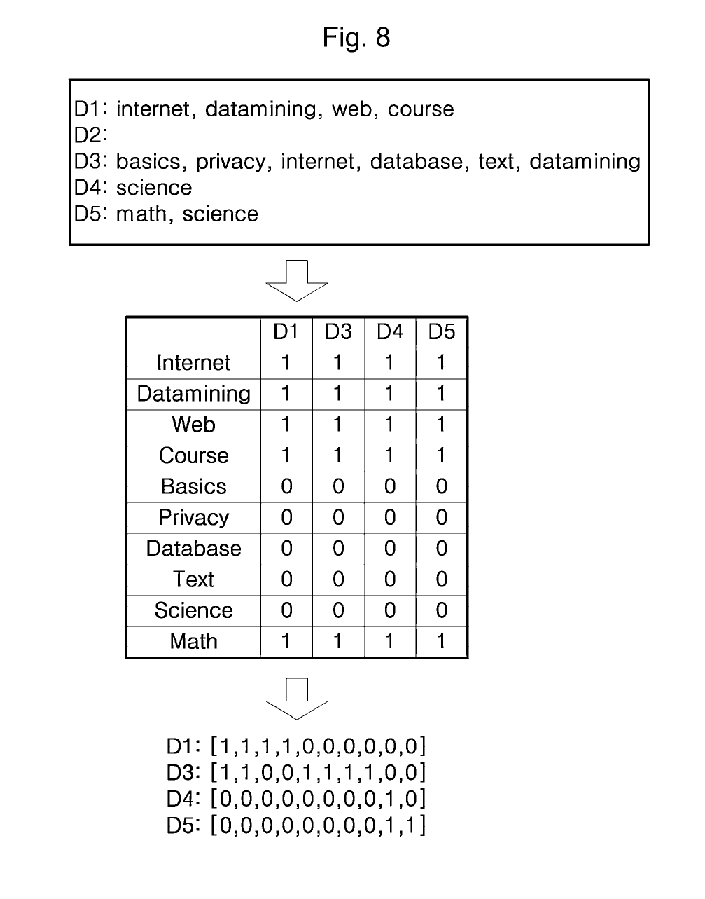

In addition, after all keywords included in the knowledge structures of the documents D3 to D5 are extracted, keywords other than “Data” are utilized as items in the vertical axis, and the searched documents are utilized as items in the horizontal axis, thereby generating a matrix of a two-dimensional structure as shown in FIG. 8.

At this time, “1” present at a point where items in the vertical axis intersects items in the horizontal axis represents that the document corresponding to the item in the horizontal axis includes a keyword corresponding to the item in the vertical axis, and “0” represents that the document corresponding to the item in the horizontal axis does not include a keyword corresponding to the item in the vertical axis. In other words, since the document D1 has a keyword “Internet”, a value at a point where the document D1 intersects the keyword “Internet” becomes “1”, and since the document D1 does not have a keyword “Text”, a value at the point where the document D1 intersects the keyword “Text” becomes “0”.

In addition, in order to display associative relations in more detail, values normalized into N-scale (N is a natural number of 3 or greater) may be used, instead of a binary number of 0 or 1. In other words, a matrix may be made to express no/yes (degree of association), instead of no/yes.

In Operation of calculating document similarity (S25), the document keyword similarity matrix generated through Operation S24 is interpreted through various similarity calculating algorithms such as cosine similarity, latent semantic analysis (LSA) or the like to calculate document similarity sim(A,B).

If the cosine similarity algorithm is used, the document similarity sim(A,B) may be calculated as follows.

$$sim ( A , B ) = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad Equation 5$$

A and B mean two documents to be compared, and i means a keyword.

If so, the similarity between the documents D1 and D3 will be calculated according to “sim(D1,D3)=(1×1+1×1+1×0+1×0+0×1+0×1+0×1+0×1+0×0+0×0)/(((1²+1² . . . +0²)^{(1/2)})×((1²+1² . . . +0² . . . )^{(1/2)}))”. In the same way, the similarity between the documents D1 and D4 will be calculated as “0”, and the similarity between the documents D1 and D5 will be calculated as “0”.

In Operation of providing or recommending a document (S26), a document providing operation or a document recommending operation is performed with reference to the document similarity calculated through Operation S25.

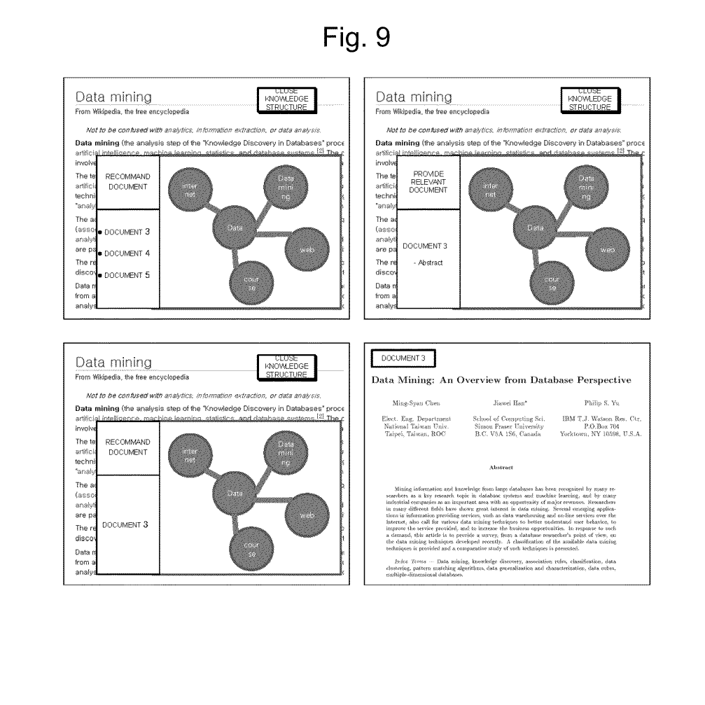

For example, referring to that the similarity between the documents D1 and D3 (sim(D1,D3)) is 0.4082483, the similarity between the documents D1 and D4 (sim(D1,D4)) is 0, and the similarity between the documents D1 and D5 (sim(D1,D5)) is 0, the apparatus for providing search service may perform various operations such as recommending relevant documents in the order of the documents D3, D4, D5 to the user as shown in Portion (a) of FIG. 9, recommending only the document D3 with highest similarity as shown in Portion (b) of FIG. 9, providing only the document D3 with highest similarity as shown in Portion (c) of FIG. 9, or directly calling and providing a detailed page of the document D3 with highest similarity as shown in Portion (d) of FIG. 9.

As described above, in the present disclosure, contents of a document interested by a person may be clearly displayed through the knowledge structure, and document similarity may be calculated through the knowledge structure, thereby allowing more accurate document recommendation or operation provision.

In addition, in the present disclosure, when searching relevant documents including an interested keyword selected by a user, their search range may be actively adjusted. In other words, the search range may be adjusted to have search precision, speed and efficiency suitable for a search service environment.

In more detail, in the present disclosure, the relevant document search range may be diversified as follows so that one relevant document search range may be selected and used among them by a user or a system manager.

First, a first scaling method allows searching a keyword based on all documents stored in a database or uploaded on the Internet. The first scaling method has highest search accuracy but slowest search speed since knowledge structures are compared based on all documents.

A second scaling method allows searching a keyword only in an initial query range without comparing all documents. Since relevant documents are searched only in a range to which the query input by a user belongs to, the second scaling method has worse accuracy than the first scaling method but faster search speed than the first scaling method.

A third scaling method classifies all documents into a hierarchy structure or an ontology form in advance and then allows searching relevant documents only in a category selected by the user. The third scaling method allows searching in a certain range, similar to the second scaling method, but all documents are put into a relevant category based on semantic elements, and searching is performed only in the category range of the corresponding document, thereby having a greater semantic search element in comparison to the second scaling method.

Even though it has been described that the relevant document search range is divided into three steps for convenience, the relevant document search range may be adjusted in more various ways in actual application.

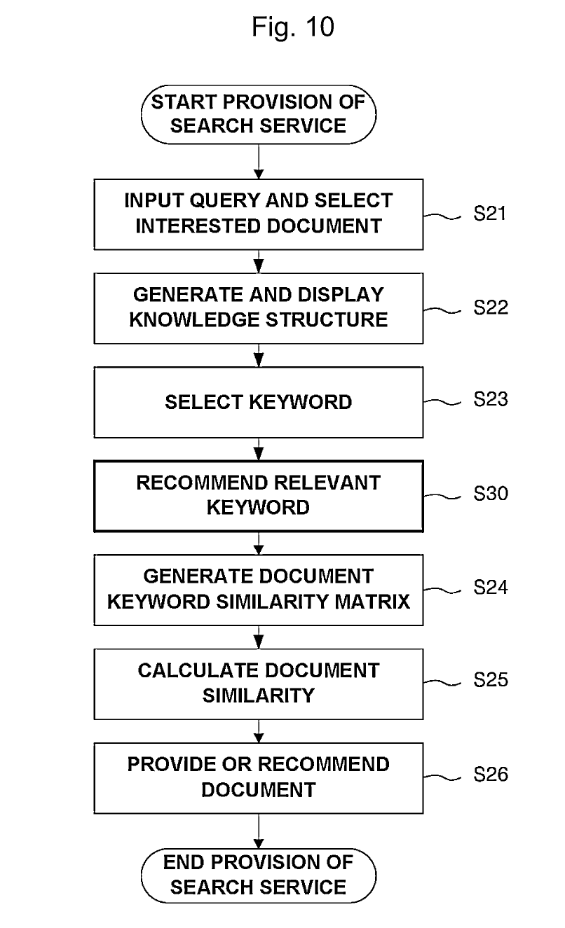

FIG. 10 is a diagram showing examples of a method for providing search service based on a knowledge structure according to another embodiment of the present disclosure.

Referring to FIG. 10, the information searching method of the present disclosure may further perform recommending a keyword associated with the selected keyword (S30) after Operation of selecting a keyword (S23) shown in FIG. 4, thereby allowing the user to newly figure out and search a keyword having close relation with the firstly selected keyword or another interested keyword.

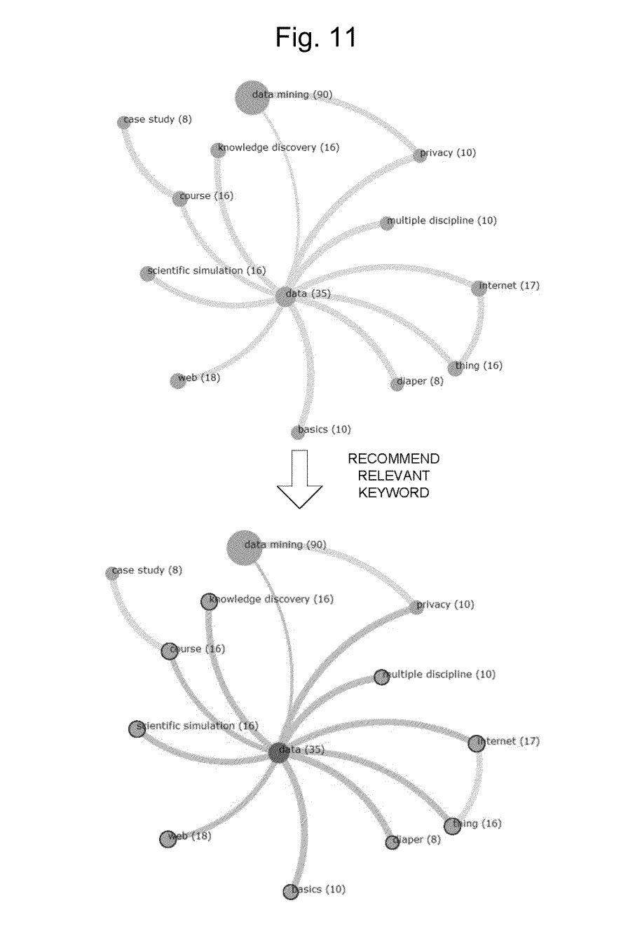

In other words, in this embodiment of the present disclosure, if the user selects one interested keyword with reference to the knowledge structure through Operation of searching a keyword (S23), links and nodes connected to the interested keyword are highlighted as shown in FIG. 11, so that the user may newly figure out and search another keyword associated with the currently selected keyword.

As a result, the user may learn new knowledge from the relations of keywords present in the knowledge structure, and further the user may more easily expand relevant knowledge through a new interested keyword.

In addition, by performing Operation of generating a document keyword similarity matrix (S24), Operation of calculating document similarity (S25), and Operation of providing or recommending a document (S26) as shown in FIG. 4 based on the newly selected interested keyword, it is possible to recommend or provide a document associated with the interested keyword newly selected by the user.

If necessary, Operations S24 to S26 may be performed to the firstly interested keyword, or Operations S24 to S26 may also be performed to both the firstly interested keyword and the newly selected interested keyword.

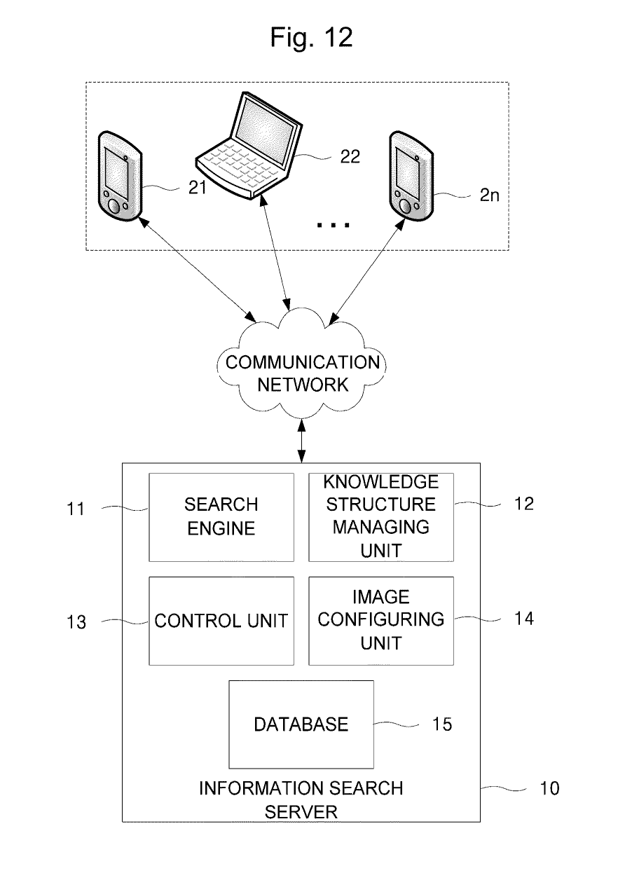

FIG. 12 is a diagram for illustrating a search service providing apparatus for providing information search service based on a knowledge structure according to an embodiment of the present disclosure.

Referring to FIG. 12, the search service providing server 10 of the present disclosure includes a search engine 11 for searching documents corresponding to a query or keyword selected by a user, a knowledge structure managing unit 12 for generating a knowledge structure corresponding to a document selected by the user among the documents searched by the search engine 11, a control unit 13 for controlling the search engine 11, the knowledge structure managing unit 12 and the image configuring unit 14 to provide the aforementioned information search service based on a knowledge structure to a user accessing the search service providing server 10, an image configuring unit 14 controlled by the control unit 13 to configure and provide a query input page, a document search result page, a knowledge structure display page, a document recommendation or provision page or the like in various ways, and a database 15 for storing and managing various documents sued for the search service.

Therefore, a plurality of Internet users may access the search service providing server 10 through their user terminals 21 to 2n, and be provided with the information search service based on a knowledge structure from the search service providing server 10 in various ways.

What is claimed is:

1. A method for providing search service based on a knowledge structure, which comprises:
searching and providing a document corresponding to a query input by a user;
generating a knowledge structure corresponding to the document and additionally providing the knowledge structure;
when one of a plurality of keywords included in the knowledge structure is selected, additionally searching relevant documents including the keyword;
calculating document similarity by comparing and analyzing the knowledge structure of the document and knowledge structures of the relevant documents; and
performing a document recommending operation or a document providing operation based on the similarity calculation result.

2. The method for providing search service based on a knowledge structure according to claim 1, wherein said calculating of document similarity includes:
when one of a plurality of keywords included in the knowledge structure is selected, additionally searching relevant documents including the keyword;
checking a knowledge structure of each of the relevant documents, and then extracting keywords included in the knowledge structure;
generating a document keyword similarity matrix of a two-dimensional structure by utilizing the relevant documents as item information in a first direction and the extracted keywords as item information in a second direction perpendicular to the first direction; and
calculating document similarity by interpreting the document keyword similarity matrix.

3. The method for providing search service based on a knowledge structure according to claim 2, wherein said calculating of document similarity uses a previously registered similarity calculating algorithm.

4. The method for providing search service based on a knowledge structure according to claim 1, before said generating of a document keyword similarity matrix, further comprising setting a search range of the relevant documents.

5. The method for providing search service based on a knowledge structure according to claim 4, wherein the search range of the relevant documents is any one of a search range including all documents uploaded on database or the Internet, a search range including documents corresponding to the query input by the user, and a search range including documents belonging to a category selected by the user.

6. The method for providing search service based on a knowledge structure according to claim 1, wherein the knowledge structure is expressed by a plurality of nodes respectively corresponding to main keywords included in the document and a plurality of links showing meaning proximity of the nodes.

7. The method for providing search service based on a knowledge structure according to claim 1, wherein in said additionally searching of relevant documents including the keyword, the selected keyword is any one of a keyword included in the knowledge structure and a recommended keyword associated with the keyword.

8. The method for providing search service based on a knowledge structure according to claim 7, further comprising, when one of a plurality of keywords included in the knowledge structure is selected, additionally displaying visual information to show links and nodes connected to a node corresponding to the selected keyword to recommend of other keywords corresponding to the selected keyword.

9. An apparatus for providing search service based on a knowledge structure, comprising:
a search engine for searching a document corresponding to a query or keyword selected by a user;
a knowledge structure managing unit for generating a knowledge structure corresponding to the document;
a control unit for acquiring and displaying documents corresponding to the query through the search engine when the query is input by the user, acquiring and displaying a knowledge structure of the selected document, and searching and recommending or providing a document having a knowledge structure most similar to the knowledge structure of the selected document when a keyword included in the knowledge structure is selected; and
a knowledge structure managing unit for generating a knowledge structure corresponding to the selected document and providing the knowledge structure to the control unit.

10. The apparatus for providing search service based on a knowledge structure according to claim 9, wherein when one of a plurality of keywords included in the knowledge structure is firstly selected, the control unit further recommends other keywords associated with the firstly selected keyword.
